(19) United States
(12) Patent Application Publication
(10) Pub. No.: US 2006/0135670 A1
(43) Pub. Date: Jun. 22, 2006

(54) Thermoplastic powder formulation for coatings having a metallic colored appearance

(75) Inventors: Alexander Richter, Recklinghausen (DE); Wolfgang Franz, Dortmund (DE); Holger Renners, Velen (DE); Thomas Schiffer, Haltern am See (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: DEGUSSA AG, Duesseldorf (DE)

(21) Appl. No.: 11/271,847

(22) Filed: Nov. 14, 2005

(30) Foreign Application Priority Data
Nov. 27, 2004 (DE) 20 2004 018 390.0

(51) Int. Cl. C08K 3/08; B05D 1/18

(52) U.S. Cl. 524/440; 427/435; 524/606

(57) ABSTRACT

A thermoplastic polymer powder composition containing a thermoplastic polymer or a powder blend of two or more thermoplastic polymers having an average particle diameter of from 40 to 250 μm, and from 0.01 to 10 parts of a metal powder.

### BACKGROUND OF THE INVENTION

1. Field of the Invention

The invention relates to a thermoplastic polymer powder composition that includes one or more thermoplastic polymers and a metal powder. The invention further relates to a process for coating a substrate that includes contacting the substrate with the thermoplastic polymer powder composition to form coating having a metallic appearance on the substrate. The invention further relates to a process for making the thermoplastic polymer composition by mixing a thermoplastic polymer with a metal powder.

2. Description of the Related Art

Thermoplastic polymer powders have been used for some decades for coating substrates including metal parts. One process for coating metal parts is carried out in a fluidized bed. The thermoplastic polymer powder is placed in a vessel having a porous base. A flow of air is blown through the vessel to fluidize the thermoplastic polymer powder. A metal part, preheated to a temperature above the melting point of the thermoplastic polymer powder, is immersed in the fluidized thermoplastic polymer powder. On contact with hot metal, the thermoplastic polymer powder melts, flows, and under appropriate operating conditions, forms a smooth, complete polymer coat on the metal surface of the metal part. In order to prevent unwanted secondary reactions of the polymer coating while still hot (e.g., oxidation by atmospheric oxygen leading to discoloration of the polymer coat), the coated metal part can be quenched while still hot (in cold water, for instance).

Since under these process conditions the polymer coating may have a comparatively high transparency it is necessary to pigment the coating to obtain a uniformly opaque coating. The pigmenting of thermoplastic polymer powders with, for example, TiO₂ is known and is frequently employed. The opacity of white TiO₂ particles is particularly high. In addition, or as an alternative to pigmenting with TiO₂, other pigments can be used in order to obtain a particular colored appearance. In this way it is possible to cover a broad spectrum of color effects from light to dark hues.

The pigmented thermoplastic polymer powder can be produced in a variety of ways, of which the two most common processes are given here by way of example: mass coloring of a thermoplastic polymer with pigments by extrusion and subsequent grinding, and coloring of a thermoplastic polymer powder with pigments in a dry-blend process.

With conventional pigments, thermoplastic polymeric coatings with generally powerful hues can be obtained and which scatter light diffusely. It is more difficult to obtain metallic coloring effects with high angle-specific degrees of reflectance. Up to a certain degree of gloss, specific inorganic phyllosilicates are suitable for this purpose, although some are sensitive to shearing. Despite the considerable advances made in recent years, commercially available metallic-colored polymeric coatings still look matt and dull as compared with highly polished metal surfaces such as brushed stainless steel or aluminum.

### SUMMARY OF THE INVENTION

Accordingly, one object of the invention is to provide a pigmented thermoplastic polymer powder whose coating on a metal part produces a metallic colored appearance, and in particular one resembling stainless steel.

Another object of the invention is to provide a process for coating a substrate with a thermoplastic coating to impart a metallic appearance to the substrate.

Another embodiment of the invention is a coating obtained by contacting a thermoplastic powder composition with a hot surface to melt and adhere the thermoplastic powder composition to the surface.

### DETAILED DESCRIPTION OF THE INVENTION

In one embodiment of the invention a thermoplastic polymer powder composition capable of providing a metallic appearance contains a mixture of a pigment and a thermoplastic polymer. The thermoplastic powder composition may further contain one or more other pigments which support the color effect. These other pigments include, for example, TiO₂, carbon black, mica, effect pigments, organic and inorganic pigments, etc. Other additives, for example, optical brighteners, heat stabilizers, acid stabilizers, flow assistants and fluidization assistants, etc., which may be used in the conventional polymer powder compositions may also be present, particularly in order to exert a positive influence on the chemical and mechanical properties of the polymer powder.

In another embodiment of the invention, the pigmented thermoplastic polymer powder may be used to coat a substrate such as a metal part with a pigmented thermoplastic polymer. The resultant coating present on the metal part exhibits a metallic colored appearance resembling stainless steel. Other heat-resistant materials, such as, for example, ceramics, can also be coated with the composition.

In a further embodiment of the invention the thermoplastic polymer powder compositions are obtained by homogeneously mixing a thermoplastic polymer powder in a dry-blend process with one or more pigments. Preferably the pigment includes a metal powder.

Suitable thermoplastic polymers include polyamides, copolyamides, polyesters, copolyesters, polyolefins (e.g., polypropylene, polyethylene), comonomer-modified polyolefins or side group-modified polyolefins (e.g., polypropylene with introduced acid groups), PVC (polyvinylchloride), polyarylene ether ketones, LCPs (liquid-crystalline polymers), PPS (polyphenylene sulfide), etc., either alone or in combination as a blend or mixture. Particular preference is given to using polyamide 11 and polyamide 12. Commercially customary polymer powders can be used, from the company Novamet, for example. The thermoplastic polymers have average particle diameters of 10 to 500 μm, preferably from 40 to 250 μm, and with particular preference have average particle diameters of from 70 to 130 μm.

The pigment such as metal powder is present in the mixture in an amount of from 0.01 to 10 parts, preferably from 0.1 to 5 parts, and very preferably from 1 to 3 parts per 100 parts of thermoplastic polymer. The metal powder is preferably chemically inert.

### EXAMPLES

### Example 1

Incorporation of Steel Pigments by Dry Blending

100 parts of VESTOSINT (precipitated polyamide 12 powder), having a particle distribution typical for fluid-bed sintering powders (d50=10 μm) were admixed in a dry-blend process with 3.2 parts of a pigment mixture containing 65% “stainless steel flake fine leafing grade” pigment from Novamet Specialty Products Corporation, 25% titanium dioxide, and 10% phyllosilicate with a layer thickness of from 40 to 200 nm. The mixture was prepared at room temperature using an MTI M20 mixer at 1,500 rpm.

### Example 2

Incorporation of Steel Pigments in a Heating/Cooling Mixer

100 parts of VESTOSINT (precipitated polyamide 12 powder), having a particle distribution typical for fluid-bed sintering powders (d50=100 μm) were admixed in a dry-blend process with up to 10 parts of “stainless steel flake fine leafing grade” pigment from Novamet Specialty Products Corporation, using a Thyssen-Henschel heating/cooling mixing combination at 2500 rpm and at elevated temperature for 3 minutes.

### Example 3

Incorporation of Steel Pigments in a Heating/Cooling Mixer

100 parts of VESTOSINT (precipitated polyamide 12 powder), having a particle distribution typical for fluid-bed sintering powders (d50=100 μm) were admixed in a dry-blend process with 1 part of “stainless steel flake fine leafing grade” pigment, using a Thyssen-Henschel heating/cooling mixing combination at 2,500 rpm and at elevated temperature for 3 minutes.

### Example 4

Coating of a Steel Part with a Pigmented Powder from Examples 1 or 2 or 3

In a fluid-bed frit, a Vestosint precipitated PA 12 powder pigmented in accordance with Example 1 or 2 or 3 was fluidized. A preheated metal part having a surface temperature of approximately 250° C. was immersed briefly in the fluid-bed frit containing the fluidized powder. Following withdrawal of the immersed metal part it was heated again subsequently if desired.

The coated metal part was cooled with water after 30 seconds and dried off. Specimens (wires, sheets, blocks) were coated with the powders produced as described. Coating took place without problems and resulted in smooth, coherent surfaces having the desired color effect with the appearance of stainless steel.

DE 202004018390.0 filed on Nov. 27, 2004, is incorporated herein by reference in its entirety.

Obviously, numerous modifications and variations of the present invention are possible in light of the above teachings. It is therefore to be understood that within the scope of the appended claims, the invention may be practiced otherwise than as specifically described herein.

1. A thermoplastic polymer powder composition, comprising:
one or more thermoplastic polymers having an average particle diameter of from 40 to 250 μm, and
from 0.01 to 10 parts by weight of one or more metal powders based on 100 parts by weight of the thermoplastic polymers.

2. The thermoplastic polymer powder composition as claimed in claim 1, comprising one or more thermoplastic polymers selected from the group consisting of a polyamide, a polyester, a polyolefin, a polyvinylchloride, a polyarylene ether ketone, a polyphenylene sulfide, and a liquid crystalline polymer.

3. The thermoplastic polymer powder composition as claimed claim 1, comprising one or more of polyamide 11 and polyamide 12.

4. The thermoplastic polymer powder composition as claimed in claim 1, wherein the metal powder is chemically inert.

5. The thermoplastic polymer powder composition as claimed in claim 1, comprising stainless steel powder.

6. The thermoplastic polymer powder composition as claimed in claim 1, further comprising one or more additives.

7. The thermoplastic polymer powder composition as claimed in claim 1, further comprising one or more additional additives selected from the group consisting of an optical brightener, a heat stabilizer, and an acid stabilizer.

8. The thermoplastic polymer powder composition as claimed in claim 1, further comprising one or more pigments.

9. The thermoplastic polymer powder composition as claimed in claim 1, further comprising one or more pigments selected from the group consisting of TiO₂, carbon black, mica, an effect pigment, an organic pigment, and an inorganic pigment.

10. The thermoplastic polymer powder composition as claimed in claim 1, wherein the thermoplastic polymers have an average particle diameter of from 70-130 μm.

11. The thermoplastic polymer powder composition as claimed in claim 1, wherein the metal powder is present in an amount of from 0.1 to 5 parts by weight.

12. The thermoplastic polymer powder composition as claimed in claim 1, wherein the metal powder is present in an amount of from 1 to 3 parts by weight.

13. The thermoplastic polymer powder composition as claimed in claim 1, comprising polyamide 12 powder, stainless steel powder, and phyllosilicate.

14. The thermoplastic polymer powder composition according to claim 13, wherein the phyllosilicate has a layer thickness of from 40 to 200 nm.

15. The thermoplastic polymer powder composition as claimed in claim 1, consisting of a thermoplastic polyamide polymer and from 1 to 3 parts by weight of stainless steel powder.

16. A coating adhered to the surface of a substrate and comprising the thermoplastic polymer powder composition as claimed in claim 1, and comprising stainless steel metal powder and at least one of polyamide 11 and 12.

17. A process, comprising:
heating an article having one or more metal surfaces,
immersing the heated article in a fluidized bed comprising the thermoplastic polymer powder composition as claimed in claim 1 to coat and melt the thermoplastic polymer powder composition on the metal surfaces, and
quenching the molten thermoplastic polymer composition by cooling.

18. A process, comprising:
contacting an article having one or more metal surfaces with the thermoplastic polymer powder composition as claimed in claim 1 to form a coating having a metallic appearance adhered to the metal surface.

19. The process as claimed in claim 17, wherein the metallic surfaces of the quenched article are coated with the thermoplastic composition and the thermoplastic composition is adhered to and in direct contact with the metal surface.

20. The process as claimed in claim 17, further comprising
reheating the coated article after the quenching.

21. A process for making the thermoplastic polymer powder composition as claimed in claim 1, comprising:
mixing the thermoplastic polymers with the metal powder to form a homogeneous mixed powder comprising the thermoplastic polymer and the metal powder.
